(19) United States
(12) Patent Application Publication
(10) Pub. No.: US 2014/0030539 A1
(43) Pub. Date: Jan. 30, 2014

(54) FOAMING COMPOSITION FOR FILLING AND SEALING, FOAMING MEMBER FOR FILLING AND SEALING, AND FOAM FOR FILLING AND SEALING

(71) Applicants: Takehiro Ui, Osaka (JP); Youhei Hayashi, Osaka (JP)

(72) Inventors: Takehiro Ui, Osaka (JP); Youhei Hayashi, Osaka (JP)

(73) Assignee: NITTO DENKO CORPORATION, Osaka (JP)

(21) Appl. No.: 14/111,358

(22) PCT Filed: Apr. 13, 2012
(86) PCT No.: PCT/JP2012/060136

§ 371 Date: Oct. 11, 2013

(30) Foreign Application Priority Data
Apr. 14, 2011 (JP) 2011-090104

(51) Int. Cl. C08J 9/00

(52) U.S. Cl. CPC C08J 9/0061
USPC 428/522; 521/96; 521/139; 521/95

(57) ABSTRACT

A foaming composition for filling and sealing contains a vinyl copolymer having an ester bond in a side chain thereof, an organic peroxide, a foaming agent, a hydrophobic resin, and a hydrophilic resin. A content ratio of the hydrophobic resin is in a range of 5 to 25 parts by mass based on 100 parts by mass of the vinyl copolymer. A content ratio of the hydrophilic resin is in a range of 1 to 20 parts by mass based on 100 parts by mass of the vinyl copolymer.

### TECHNICAL FIELD

The present invention relates to a foam for filling and sealing which is used to fill a gap between various members and an inner space of a hollow member and seal them, and a foaming member for filling and sealing and a foaming composition for filling and sealing, each for forming the foam for filling and sealing.

### BACKGROUND ART

Conventionally, it has been known to fill a hollow space of a hollow member, which is formed as a closed cross section of an automotive pillar or the like, with a foam as a filler for the purpose of preventing the vibration and noise of an engine, wind noise, and the like from being transmitted to a vehicle interior.

For example, it has been proposed that a foaming composition for filling containing an ethylene-vinyl acetate copolymer, dicumyl peroxide, and azodicarbonamide is prepared and heated to be foamed to obtain a foam for filling (see, e.g., Patent Document shown below).

### PRIOR ART DOCUMENT

### Patent Document

Patent Document 1: Japanese Unexamined Patent No. 2009-091558

### SUMMARY OF THE INVENTION

### Problems to be Solved by the Invention

However, after the hollow space of the automotive pillar is filled with the foam for filling of Patent Document 1 shown above, when rainwater enters the hollow space of the pillar, the rainwater may be absorbed by the foam for filling of Patent Document 1 shown above to corrode the pillar and, consequently, rust may develop in the pillar.

In addition, the foam for filling using azodicarbonamide as a foaming agent tends to have an adhesion strength with respect to the pillar which is lower than that of a foam for filling using 4,4′-oxybis(benzene sulfonyl hydrazide). Accordingly, the sealability thereof may not be sufficient.

An object of the present invention is to provide a foam for filling and sealing having an excellent sealability, and a foaming member for filling and sealing and a foaming composition for filling and sealing, each for forming the foam for filling and sealing, while suppressing the water absorption rate thereof

### Means for Solving the Problems

To attain the foregoing object, a foaming composition for filling and sealing of the present invention contains a vinyl copolymer having an ester bond in a side chain thereof, an organic peroxide, a foaming agent, a hydrophobic resin, and a hydrophilic resin, wherein a content ratio of the hydrophobic resin is in a range of 5 to 25 parts by mass based on 100 parts by mass of the vinyl copolymer, and a content ratio of the hydrophilic resin is in a range of 1 to 20 parts by mass based on 100 parts by mass of the vinyl copolymer.

In the foaming composition for filling and sealing of the present invention, it is preferable that the vinyl copolymer is an ethylene-vinyl acetate copolymer.

In the foaming composition for filling and sealing of the present invention, it is preferable that the hydrophobic resin is at least one synthetic rubber selected from the group consisting of a styrene-butadiene rubber, an acrylonitrile-butadiene rubber, and a butyl rubber.

In the foaming composition for filling and sealing of the present invention, it is preferable that the hydrophilic resin is an epoxy resin and/or a polyamide resin.

In the foaming composition for filling and sealing of the present invention, it is preferable that the foaming agent is azodicarbonamide.

A foaming member for filling and sealing of the present invention includes a foaming composition for filling and sealing, and a fitting member attached to the foaming composition for filling and sealing to be capable of being mounted in an inner space of a hollow member, wherein the foaming composition for filling and sealing contains a vinyl copolymer having an ester bond in a side chain thereof, an organic peroxide, a foaming agent, a hydrophobic resin, and a hydrophilic resin, a content ratio of the hydrophobic resin is in a range of 5 to 25 parts by mass based on 100 parts by mass of the vinyl copolymer, and a content ratio of the hydrophilic resin is in a range of 1 to 20 parts by mass based on 100 parts by mass of the vinyl copolymer.

A foam for filling and sealing of the present invention is obtained by foaming a foaming composition for filling and sealing containing a vinyl copolymer having an ester bond in a side chain thereof, an organic peroxide, a foaming agent, a hydrophobic resin, and a hydrophilic resin, wherein a content ratio of the hydrophobic resin is in a range of 5 to 25 parts by mass based on 100 parts by mass of the vinyl copolymer, and a content ratio of the hydrophilic resin is in a range of 1 to 20 parts by mass based on 100 parts by mass of the vinyl copolymer.

### Effect of the Invention

The foam for filling and sealing of the present invention obtained by foaming the foaming member for filling and sealing of the present invention including the foaming composition for filling and sealing of the present invention has a suppressed water absorption rate.

Therefore, it is possible to prevent the degradation of the members and the hollow member resulting from the entrance of water into the gap between the members or into the inner space of the hollow member.

In addition, the foam for filling and sealing of the present invention has excellent adhesion to the members and the hollow member. As a result, the foam for filling and sealing of the present invention shows an excellent sealability with respect to the gap between the members and the inner space of the hollow member.

### BRIEF DESCRIPTION OF THE DRAWINGS

FIG. 1 is a process step view of a method of filling and sealing an inner space of an automotive pillar using an embodiment of a foaming composition for filling and sealing, a foaming member for filling and sealing, and a foam for filling and sealing of the present invention,

FIG. 1(a) showing the step of attaching a fitting member to the foaming composition for filling and sealing to produce the foaming member for filling and sealing, and placing it in the pillar, and

FIG. 1(b) showing the step of foaming, cross-linking, and curing the foaming composition for filling and sealing by heating to fill the inner space of the pillar with the foam for filling and sealing and seal it;

FIG. 2 is a process step view illustrating a method of measuring a tensile shear adhesion strength in EXAMPLES, which shows the step of placing a sheet on a first steel plate and preparing a second steel plate;

FIG. 3 is a process step view illustrating the method of measuring the tensile shear adhesion strength in EXAMPLES subsequently to FIG. 2, which shows the step of placing the first steel plate and the second steel plate such that the first and second steel plates face each other with the sheet being interposed therebetween,

FIG. 3(a) showing a cross-sectional view, and

FIG. 3(b) showing a plan view; and

FIG. 4 is a process step view illustrating the method of measuring the tensile shear adhesion strength in EXAMPLES subsequently to FIG. 3, which shows the step of heating the sheet to obtain a foam for filling and sealing and then pulling the first steel plate with respect to the second steel plate,

FIG. 4(a) showing a cross-sectional view, and

FIG. 4(b) showing a plan view.

### EMBODIMENT OF THE INVENTION

A foaming composition for filling and sealing of the present invention contains a vinyl copolymer, an organic peroxide, a foaming agent, a hydrophobic resin, and a hydrophilic resin.

The vinyl copolymer has an ester bond (—COO—) in a side chain thereof, and specific examples thereof include a copolymer of a vinyl-group-containing ester and an olefin, and the like.

Examples of the vinyl-group-containing ester include fatty acid vinyl ester, (meth)acrylate, and the like.

Examples of the fatty acid vinyl ester include vinyl acetate, vinyl propionate, vinyl butyrate, and the like.

The (meth)acrylate is an acrylate and/or methacrylate. Examples of the (meth)acrylate include methyl(meth)acrylate, ethyl(meth)acrylate, propyl(meth)acrylate, isopropyl(meth)acrylate, butyl(meth)acrylate, and the like.

These vinyl-group-containing esters can be used alone or in combination.

As the vinyl-group-containing ester, the fatty acid vinyl ester is used preferably or, more preferably, the vinyl acetate is used.

Examples of the olefin include ethylene, propylene, and the like. These olefins can be used alone or in combination.

As the olefin, ethylene is used preferably.

Specific examples of the foregoing vinyl copolymer include an olefin-fatty acid vinyl ester copolymer such as ethylene-vinyl acetate copolymer (EVA), ethylene-vinyl propionate copolymer, ethylene-vinyl butyrate copolymer, or ethylene-propylene-vinyl acetate copolymer, an olefin-(meth)acrylate copolymer such as ethylene-methyl(meth)acrylate copolymer, ethylene-ethyl(meth)acrylate copolymer, ethylene-propyl(meth)acrylate copolymer, or ethylene-butyl(meth)acrylate copolymer, and the like.

The foregoing vinyl copolymer is a block copolymer or random copolymer.

These vinyl copolymers can be used alone or in combination of two or more kinds.

As the vinyl copolymer, the olefin-fatty acid vinyl ester copolymer is used preferably or, more preferably, the EVA is used in terms of foamability and compatibility with the hydrophobic resin described next.

The content ratio of the vinyl-group-containing ester (specifically fatty acid vinyl ester, or preferably vinyl acetate) in the vinyl copolymer is in a range of, e.g., 5 to 60 mass %, or preferably 10 to 45 mass %.

The melt flow rate (MFR) of the vinyl copolymer is in a range of, e.g., not more than 5.0 g/10 min, or preferably not more than 4.5 g/10 min and, e.g., not less than 1.0 g/10 min, or preferably not less than 1.5 g/10 min.

The organic peroxide is a cross-linking agent for cross-linking the vinyl copolymer, which is, e.g., a radical forming agent decomposed by heating to be able to produce a free radical and allow cross-linking of the vinyl copolymer. Examples of the organic peroxide include dicumyl peroxide (DCP), 1,1-di-tertiary-butyl-peroxy-3,3,5-tri-methyl-cyclohexane, 2,5-dimethyl-2,5-di-tertiary-butyl-peroxyhexane, 1,3-bis(tertiary-butyl-peroxy-isopropyl)benzene, tertiary-butyl-peroxyketone, tertiary-butyl-peroxybenzoate, and the like.

These organic peroxides can be used alone or in a combination of two or more kinds.

As the organic peroxide, DCP is used preferably.

The content ratio of the organic peroxide is in a range of 0.1 to 10 parts by mass, or preferably 0.5 to 5 parts by mass based on 100 parts by mass of the vinyl copolymer. When the content ratio of the organic peroxide is less than the ranges shown above, a viscosity increase resulting from cross-linking is small and foam cells may be broken due to the pressure of a gas during foaming. On the other hand, when the content ratio of the organic peroxide exceeds the foregoing ranges, cross-linking excessively proceeds and a coating of the vinyl copolymer suppresses the gas pressure during foaming. As a result, foaming at a high expansion ratio is unlikely to occur.

Examples of the foaming agent include an inorganic foaming agent, an organic foaming agent, and the like.

Examples of the inorganic foaming agent include ammonium carbonate, ammonium hydrogen carbonate, sodium hydrogen carbonate, ammonium nitrite, sodium borohydride, azide, and the like.

Examples of the organic foaming agent include N-nitroso compounds such as N,N′-dinitrosopentamethylenetetramine and N,N′-dimethyl-N,N′-dinitrosoterephthalamide, azo compounds such as azobisisobutyronitrile, azodicarbonamide (ADCA), and barium azodicarboxylate, alkane fluorides such as trichloromonofluoromethane and dichloromonofluoromethane, hydrazine compounds such as paratoluene sulfonyl hydrazide, diphenylsulfone-3,3′-disulfonyl hydrazide, 4,4′-oxybis (benzene sulfonyl hydrazide), and allylbis (sulfonyl hydrazide), semicarbazide compounds such as p-toluoylenesulfonyl semicarbazide, 4,4′-oxybis(benzene sulfonyl semicarbazide), triazole compounds such as 5-morphoryl-1,2,3,4-thiatriazole, and the like.

Note that, as the foaming agent, there can also be used a thermoexpansive particulate in which a thermoexpansive material (such as, e.g., isobutane or pentane) is encapsulated in a microcapsule (microcapsule made of a thermoplastic resin such as, e.g., vinylidene chloride, acrylonitrile, acrylate, or methaclylic acid ester) or the like.

These foaming agents can be used alone or in a combination of two or more kinds.

As the foaming agent, the organic foaming agent is used preferably, the azo-based compound is used more preferably, or the ADCA is used particularly preferably in terms of generating a large amount of gas and improving safety.

The content ratio of the foaming agent is in a range of, e.g., 5 to 20 parts by mass, or preferably 10 to 17 parts by mass based on 100 parts by mass of the vinyl copolymer. When the content ratio of the foaming agent is less than the lower limit value shown above, foaming may not sufficiently proceed to degrade a fillability and a sealability. When the content ratio of the foaming agent is more than the upper limit value shown above, a density may excessively decrease to degrade the sealability or increase a water absorption rate.

When the vinyl copolymer described above is hydrophobic, the hydrophobic resin is a synthetic resin other than the vinyl copolymer and has an SP value of less than 22.0.

Examples of such a hydrophobic resin include synthetic rubbers such as a styrene-butadiene rubber (SBR which is a styrene-butadiene copolymer having an SP value of 17.2 to 17.8), an acrylonitrile-butadiene rubber (NBR which is an acrylonitrile-butadiene copolymer having an SP value of 17.6 to 21.5), a butadiene rubber (BR which is a 1,3-butadiene homopolymer having an SP value of 14.7 to 18.6), an isoprene rubber (IR having an SP value of 16.6), a butyl rubber (IIR which is an isobutene-isoprene rubber or isobutene-isoprene copolymer having an SP value of 15.0 to 17.0), an ethylene-propylene rubber (EPM having an SP value of 16.0 to 17.5, a fluorine rubber (having an SP value of 14.9), and the like.

These hydrophobic resins mentioned above can be used alone or in a combination of two or more kinds.

As the hydrophobic resin, in terms of adhesion to a metal plate such as a steel plate, SBR, NBR, BR, IR, or IIR is used preferably or, more preferably, SBR, NBR, or IIR is used more preferably.

The SP value of the hydrophobic resin is preferably not more than 21.0, more preferably not more than 20.0, or particularly preferably not more than 18.0 and normally not less than 14.0.

The SP value of the hydrophobic resin is calculated by measuring evaporation heat.

Note that, when the hydrophobic resin is a copolymer such as SBR, NBR, IIR, EPM, or the like, the SP value of the hydrophobic resin varies in accordance with the ratio (content) of each of the monomers composing the copolymer.

Specifically, in an exemplary case where the hydrophobic resin is SBR, when the content of styrene is 15 mass %, the SP value is in a range of, e.g., 17.2 to 17.6 and, when the content of styrene is 25 mass %, the SP value is in a range of, e.g., 17.6 to 17.8.

In an exemplary case where the hydrophobic resin is NBR, when the content of acrylonitrile is 18 mass %, the SP value is in a range of, e.g., 17.6 to 19.2 and, when the content of acrylonitrile is 25 mass %, the SP value is in a range of, e.g., 19.0 to 20.3. Furthermore, when the content of acrylonitrile is 30 mass % or 33.5 mass %, the SP value is in a range of, e.g., 19.2 to 20.3 and, when the content of acrylonitrile is 39 mass %, the SP value is in a range of, e.g., 21.1 to 21.5.

In an exemplary case where the hydrophobic resin is IIR, when the degree of unsaturation (i.e., the ratio of isoprene) is in a range of 0.5 to 3 mol %, the SP value is in a range of, e.g., 15.8 to 16.7.

The Mooney viscosity (ML1+4) of the hydrophobic resin at 100° C. is in a range of, e.g., 20 to 50 in the case where SBR or NBR is used. On the other hand, the Mooney viscosity (ML1+8) thereof at 125° C. is in a range of, e.g., 30 to 100 in the case where IIR is used.

The content ratio of the hydrophobic resin is in a range of 5 to 25 parts by mass, or preferably 7 to 20 parts by mass based on 100 parts by mass of the vinyl copolymer. When the content ratio of the hydrophobic resin is more than the upper limit value shown above, the adhesion to the metal plate may deteriorate. On the other hand, when the content ratio of the hydrophobic resin is less than the lower limit value shown above, the water absorption rate may rise.

When the vinyl copolymer described above is hydrophilic, the hydrophilic resin is a synthetic resin other than the vinyl copolymer and has an SP value of not less than 22.0.

Examples of such a hydrophilic resin include a polyamide resin (having an SP value of 27.8), polyvinyl alcohol (having an SP value of 25.8), polyvinylidene chloride (having an SP value of 25.0), an epoxy resin (having an SP value of 22.3), polyethylene terephthalate (having an SP value of 22.3), and the like.

The SP value of the hydrophilic resin is calculated by measuring evaporation heat.

These hydrophilic resins can be used alone or in a combination of two or more kinds.

As the hydrophilic resin, in terms of improving adhesion and processability, the polyamide resin or the epoxy resin is used preferably.

The polyamide resin is obtained by condensation polymerization of a dicarboxylic acid such as, e.g., an adipic acid or a dimer acid and a diamine such as, e.g., ethylenediamine or hexamethylenediamine.

Examples of the epoxy resin include an aromatic epoxy resin such as a bisphenol type epoxy resin (such as, e.g., bisphenol A type epoxy resin, bisphenol F type epoxy resin, bisphenol S type epoxy resin, hydrogenated bisphenol A type epoxy resin, or dimer-acid-modified bisphenol type epoxy resin), a novolak type epoxy resin (such as, e.g., phenol novolak type epoxy resin, cresol novolak type epoxy resin, or biphenyl type epoxy resin), or a naphthalene type epoxy resin, an aliphatic epoxy resin, an alicyclic epoxy resin, a glycidyl ether type epoxy resin, a glycidyl amine type epoxy resin, and the like.

The epoxy equivalent of the epoxy resin is in a range of, e.g., 100 to 1000 g/eqiv., or preferably 180 to 700 g/eqiv.

These epoxy resins can be used alone or in combination.

As the epoxy resin, the aromatic epoxy resin is used preferably or, more preferably, the bisphenol type epoxy resin is used.

The epoxy resin can also be blended with a curing agent and a curing accelerator to be prepared as an epoxy resin composition.

The curing agent is a latent curing agent (epoxy resin curing agent) which can cure the epoxy resin through heating. Examples of the curing agent include an amine compound, an acid anhydride compound, an amide compound, a hydrazide compound, an imidazoline compound, and the like.

Examples of the amine compound include polyamines such as ethylenediamine, propylenediamine, diethylenetriamine, and triethylenetetramine, amine adducts thereof, metaphenylenediamine, diaminodiphenylmethane, diaminodiphenylsulfone, and the like.

Examples of the acid anhydride compound include phthalic anhydride, maleic anhydride, tetrahydrophthalic anhydride, hexahydrophthalic anhydride, 4-methyl-hexahydrophthalic anhydride, methylnadic anhydride, pyromellitic anhydride, dodecenylsuccinic anhydride, dichlorosuccinic anhydride, benzophenonetetracarboxylic anhydride, chlorendic anhydride, and the like.

Examples of the amide compound include dicyandiamide (DICY), polyamide, and the like.

Examples of the hydrazide compound include adipic dihydrazide, and the like.

Examples of the imidazoline compound include methylimidazoline, 2-ethyl-4-methylimidazoline, ethylimidazoline, isopropylimidazoline, 2,4-dimethylimidazoline, phenylimidazoline, undecylimidazoline, heptadecylimidazoline, 2-phenyl-4-methylimidazoline, and the like.

These curing agents can be used alone or in combination of two or more kinds.

As the curing agent, the amide compound is used preferably.

The content ratio of the curing agent is in a range of, e.g., 0.5 to 50 parts by mass, or preferably 1 to 20 parts by mass based on 100 parts by mass of the epoxy resin.

Examples of the curing accelerator include an imidazole compound such as 2-phenylimidazole, 2-methylimidazole, 2-ethyl-4-methylimidazole, 2-phenyl-4-methyl-5-hydroxymethylimidazole, 2,4-diamino-6[2′-methylimidazolyl-(1′)]-ethyl-s-triazine, or an isocyanuric acid adduct thereof, a tertiary amine compound such as triethylenediamine or tri-2,4,6-dimethylaminomethylphenol, a phosphorus compound such as triphenylphosphine, tetraphenylphosphoniumtetraphenylborate, or tetra-n-butylphosphonium-o,o-diethylphosphorodithioate, a quaternary ammonium salt compound, an organic metal salt compound, and the like.

These curing accelerators can be used alone or in combination.

As the curing accelerator, the imidazole compound is used preferably.

The content ratio of the curing accelerator is in a range of, e.g., 0.1 to 10 parts by mass, or preferably 0.2 to 5 parts by mass based on 100 parts by mass of the epoxy resin.

The SP value of the hydrophilic resin is preferably not less than 22.2 and normally not more than 29.

The SP value of the hydrophilic resin is defined (or calculated) by the same method by which the SP value of the hydrophobic resin is defined (or calculated) described above.

Note that the PS value of the epoxy resin is substantially the same as the SP value of the epoxy resin composition.

The content ratio of the hydrophilic resin is in a range of, e.g., 1 to 20 parts by mass, or preferably 2 to 15 parts by mass based on 100 parts by mass of the vinyl copolymer. When the content ratio of the hydrophilic resin is more than the upper limit value shown above, the water absorption rate may rise. On the other hand, when the content ratio of the hydrophilic resin is less than the lower limit value shown above, the adhesion to the metal plate may deteriorate.

The blending ratio between the hydrophobic resin and the hydrophilic resin as the mass ratio (Number of Parts by Mass of Hydrophobic Resin/Number of Parts by Mass of Hydrophilic Resin) therebetween is in a range of, e.g., 1/2 to 5/1, or preferably 1/1 to 4/1 in terms of achieving each of the suppression of the water absorption rate and an improvement in adhesion.

To the foaming composition for filling and sealing of the present invention, known additives such as, e.g., cross-linking auxiliary agent, foaming auxiliary agent, softener, other additional processing aid, basic oxide, stabilizer, plasticizer, oxidation inhibitor, antioxidant, pigment, coloring agent, antifungal agent, and fire retardant can also be added at an appropriate ratio in a range which does not inhibit the excellent effects of the present invention.

The cross-linking auxiliary agent is blended as necessary in order to adjust the degree of cross-linking of the vinyl copolymer and ensure a high expansion ratio.

Specific examples of the cross-linking auxiliary agent include a functional-group-containing compound having at least three functional groups.

Examples of the functional groups contained in the functional-group-containing compound include (meth)acryloyl group (i.e., acryloyl group (—COCH═CH₂) and/or methacryloyl group (—CO—C(CH₃)═CH₂), allyl group (—CH₂CH═CH₂), hydroxyimino group (═N—OH), imino group (═NH), amino group (—NH₂), imide group (—CO—NH—CO—), carboxyl group (—COOH), vinyl group (—CH═CH₂), and the like. Preferably, the (meth)acryloyl group is contained.

Specific examples of the functional-group-containing compound include (meth)acryloyl-group-containing compounds (i.e., acryloyl-group-containing compounds and/or methacryloyl-group-containing compounds) such as trimethylol propane triacrylate (TMPTA), trimethylol propane trimethacrylate, pentaerythritol tri(meth)acrylate, pentaerythritol tetra(meth)acrylate, and dipentaerythritol hexa(meth)acrylate, allyl-group-containing compounds such as triallyl isocyanurate (TAIC) and triallyl cyanurate (TAC), hydroxyimino-group-containing compounds (e.g., oximes) such as p-quinone dioxime, imino- and amino-group-containing compounds such as guanidine, imide-group-containing compounds such as N,N′-m-phenylene bismaleimide, carboxyl-group-containing compounds (e.g., unsaturated fatty acid metal salts) such as zinc acrylate, vinyl-group-containing compounds such as 1,2-polybutadiene, and the like.

These cross-linking accelerators can be used alone or in combination.

As the cross-linking accelerator, the (meth)acryloyl-group-containing compound is used preferably.

If the cross-linking accelerator is the (meth)acryloyl-group-containing compound, strong cross-linking due to a (meth)acryloyl group can be achieved.

The content ratio of the cross-linking accelerator is in a range of, e.g., 0.05 to 1.5 parts by mass, or preferably 0.1 to 1.0 parts by mass based on 100 parts by mass of the vinyl copolymer.

The foaming auxiliary agent is blended as necessary to efficiently cause foaming due to the foaming agent at a temperature (in a range of, e.g., 140 to 180° C.) during the step of manufacturing a hollow member (specifically, during the baking finishing of an automobile).

Examples of the foaming auxiliary agent include urea compounds, higher fatty acids such as salicylic acid and stearic acid or metal salts thereof (e.g., zinc salt), metal oxides such as zinc oxide, and the like. In terms of storage stability, higher fatty acid zinc or zinc oxide produced by a dry method is preferably used.

The content ratio of the foaming auxiliary agent is in a range of, e.g., 1 to 20 parts by mass, or preferably 2 to 10 parts by mass based on 100 parts by mass of the vinyl copolymer.

The softener is blended as necessary so as to soften the vinyl copolymer and set the foaming composition for filling and sealing to a desired viscosity. Examples of the softener include drying oils and animal/vegetable oils (such as e.g., paraffins (such as paraffin-based oils), waxes, naphtenes, aromatic oils, asphalts, and flaxseed oils), petroleum-derived oils, terpene polymers, rosin-based resins, terpene-based resins, coumarone-indene-based resins, petroleum-based resins (such as, e.g., aliphatic hydrocarbon resins, aliphatic/aromatic hydrocarbon resins, and aromatic hydrocarbon resins), organic acid esters (such as, e.g., phthalates, phosphoric acid esters, higher fatty acid esters, and alkylsulfonic acid esters), tackifiers, and the like.

The content ratio of the softener is in a range of, e.g., 1 to 50 parts by mass, or preferably 5 to 25 parts by mass based on 100 parts by mass of the vinyl copolymer.

For the foaming composition for filling and sealing of the present invention, the individual components shown above are blended at the content ratios shown above, and uniformly mixed. The foaming composition for filling and sealing can be prepared by kneading the components shown above with, e.g., a mixing roll, a pressure kneader, an extruder, or the like.

Kneading conditions include a heating temperature in a range of, e.g., 50 to 130° C., or preferably 95 to 120° C., and a heating time in a range of, e.g., 0.5 to 30 minutes, or preferably 1 to 20 minutes.

In the preparation, the foaming composition for filling and sealing can also be prepared as a preform by molding the obtained kneaded product into a predetermined shape.

Molding of the kneaded product is performed by, e.g., molding the kneaded product directly into a predetermined shape (e.g., a sheet-like shape) by calender-molding or press-molding. Alternatively, the kneaded product is, e.g., pelletized using a pelletizer or the like, and molded into a predetermined shape using an injection molder or an extrusion molder.

Molding conditions include a molding temperature in a range of, e.g., 60 to 120° C., or preferably 75 to 105° C.

The viscosity (measured at a temperature of 120° C. and under a pressure of 500 MPa in a flow tester) of the foaming composition for filling and sealing thus obtained is in a range of, e.g., 1000 to 5000 Pa·s.

By heating the foaming composition for filling and sealing of the present invention thus obtained under appropriate conditions to cause the foaming, cross-linking, and curing thereof, the foam for filling and sealing of the present invention can be formed.

The foam for filling and sealing of the present invention thus obtained has a density (Foam Mass (g)/Foam Volume (cm³)) which is in a range of, e.g., 0.04 to 0.2 g/cm³, or preferably 0.05 to 0.08 g/cm³ and a volume expansion ratio during foaming (=Pre-Foaming Density/Post-Foaming Density) which is in a range of, e.g., not less than 5, or preferably 8 to 40. Such a volume expansion ratio allows a gap between members or an inner space of a hollow member to be filled with the foam for filling and sealing with substantially no void space left therein even when the gap or the inner space has a complicated shape, and allows the gap between the members or the inner space of the hollow member to be sealed (sealed).

The water absorption rate of the foam for filling and sealing is in a range of, e.g., not more than 10.0 mass %, or preferably not more than 5.0 mass % and normally, e.g., not less than 0.01 mass %.

The water absorption rate of the foam for filling and sealing is measured in accordance with evaluation in Examples described later.

The tensile shear adhesion strength of the foam for filling and sealing is in a range of, e.g., not less than 0.50 MPa, preferably 0.60 MPa and normally, e.g., not more than 10.0 MPa.

The tensile shear adhesion strength of the foam for filling and sealing is measured in accordance with the evaluation in Examples described later.

The state of failure of the foam for filling and sealing when tensile shear has occurred therein is preferably a cohesive failure (state in which the foam for filling and sealing is internally sheared).

The foam for filling and sealing of the present invention thus obtained can give various effects such as reinforcement, vibration control, sound insulation, dust control, heat insulation, buffering, and watertightness to various members. Therefore, the foam for filling and sealing of the present invention can be used preferably as fillers/sealers for various industrial products with which a gap between various members and an inner space of a hollow member are to be filled and sealed, such as, e.g., a reinforcement material, a vibration control material, a sound insulator, a dust control material, a heat insulator, a buffering material, and a waterstop material.

A method of filling and sealing a gap between various members and an inner space of a hollow member is not particularly limited but, for example, the foaming composition for filling and sealing is placed in the gap between the members to be filled or in the inner space of the hollow member to be filled. Then, the placed foaming composition for filling and sealing is heated to be foamed, cross-linked, and cured to form the foam for filling and sealing. With the foam for filling and sealing, the gap between the members and the inner space of the hollow member are filled and sealed (sealed).

More specifically, in the case of filling and sealing, e.g., the inner space of the hollow member, a fitting member is attached first to the foaming composition for filling and sealing to produce a foaming member for filling and sealing. The fitting member of the foaming member for filling and sealing is mounted in the inner space of the hollow member, and then the foaming member for filling and sealing is foamed by heating to form the foam for filling and sealing. With the foam for filling and sealing, the inner space of the hollow member can be filled and sealed.

Examples of such a hollow member include a pillar made of a metal (specifically, made of steel or the like) in an automobile. After the foaming member for filling and sealing is produced from the foaming composition for filling and sealing of the present invention and mounted in the inner space of the pillar, if the foaming member for filling and sealing is foamed, the obtained foam for filling and sealing allows the vibration and noise of an engine, wind noise, and the like to be effectively prevented from being transmitted to a vehicle interior, while achieving sufficient reinforcement of the pillar.

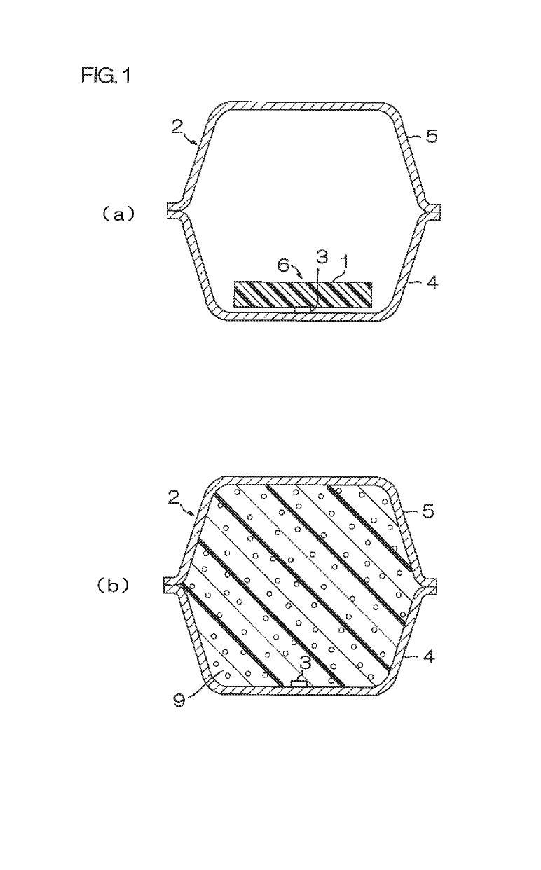

FIG. 1 is a process step view of a method of filling and sealing an inner space of an automotive pillar using an embodiment of the foaming composition for filling and sealing, the foaming member for filling and sealing, and the foam for filling and sealing of the present invention.

Next, as the embodiment of the foaming composition for filling and sealing, the foaming member for filling and sealing, and the foam for filling and sealing of the present invention, the method of filling and sealing the inner space of the automotive pillar using them is described.

First, in the method, as shown in FIG. 1(a), a foaming composition for filling and sealing 1 molded into a predetermined shape is placed in a pillar 2.

The foaming composition for filling and sealing 1 is formed into, e.g., a sheet shape.

The pillar 2 includes an inner panel 4 and an outer panel 5 each having a generally depressed cross-sectional shape. The inner panel 4 is formed such that the center portion thereof protrudes from the peripheral end portion thereof on one side (lower side in FIG. 1) of the pillar 2 in the thickness direction thereof.

The outer panel 5 is formed such that the center portion thereof protrudes from the peripheral end portion thereof on the other side (upper side in FIG. 1) of the pillar 2 in the thickness direction thereof.

To place the foaming composition for filling and sealing 1 in the pillar 2, a fitting member 3 is first attached to the foaming composition for filling and sealing 1 to produce a foaming member for filling and sealing 6 including the fitting member 3 and the foaming composition for filling and sealing 1. Subsequently, the fitting member 3 of the foaming member for filing and sealing 6 is attached to the inner peripheral surface of the pillar 2.

Alternatively, the fitting member 3 can also be insert-molded together with the kneaded product during the molding of the foaming composition for filling and sealing 1.

After the foaming composition for filling and sealing 1 is placed in the inner panel 4 via the fitting member 3, the peripheral end portions of the inner panel 4 and the outer panel 5 are caused to face and touch each other and joined together. As a result, the pillar 2 is formed as a closed cross section.

More specific examples of such a pillar 2 include a front pillar of a vehicle body, a side pillar thereof, a rear pillar thereof, and the like.

Then, in the method, using heat in the subsequent dry line step during baking finishing, the pillar 2 is heated at a temperature in a range of, e.g., not less than 140° C. and not more than 180° C., or preferably not less than 160° C. and not more than 180° C. In this manner, as shown in FIG. 1(b), the foaming composition for filling and sealing 1 is foamed, cross-linked, and cured to be able to form a foam for filling and sealing 9. With the foam for filling and sealing 9, the inner space of the pillar 2 can be filled with substantially no void space left therein and sealed.

Note that the shape of the foaming composition for filling and sealing 1, the position and orientation where the foaming composition for filling and sealing 1 is placed, and the number of the foaming compositions for filling and sealing 1 to be placed are selectively and appropriately determined in accordance with the shape of the pillar 2 or the like.

The foam for filling and sealing 9 obtained by foaming the foregoing foaming member for filling and sealing 6 including the foaming composition for filling and sealing 1 has the suppressed water absorption rate.

Therefore, the foam for filling and sealing 9 can prevent the degradation of the pillar 2 resulting from the entrance of water (specifically, water such as rainwater) into the inner space of the pillar 2.

In addition, the foam for filling and sealing 9 described above has excellent adhesion to the pillar 2. Accordingly, the sealability thereof with respect to the inner space of the pillar 2 is excellent.

### EXAMPLES

While in the following, the present invention will be described more specifically by showing Examples and Comparative Examples, the present invention is not limited thereto.

### Examples 1-6, and Comparative Examples 1 to 8

In accordance with the blending formulations shown in Tables 1 and 2, the individual components were kneaded using a 6-inch mixing roll at a rotation speed of 15 min⁻¹ and about 110° C. for 10 minutes to prepare kneaded products (foaming compositions for filling and sealing). Then, the prepared kneaded products were molded by pressing at 90° C. into sheets each having a thickness of 2 mm.

(Evaluation)

Each of the sheets obtained in Examples and Comparative Examples was individually evaluated for the following items. The result of the evaluation is shown in Tables 1 and 2.

(1) Expansion Ratio

The sheets were punched into disc shapes each having a diameter of 19 mm to produce samples. Each of the produced samples was heated at 160° C. for 20 minutes to be foamed. Then, from the densities of the sheets before and after foaming, expansion ratios were calculated.

(2) Water Absorption Rate

First, the sheets were punched into rectangular shapes each having a size of 10×18 mm to produce samples and the masses (A1) of the produced samples were measured.

Meanwhile, cold-rolled steel plates each having a thickness of 0.8 mm and a size of 25×150 mm were prepared and the mass (B) of each of the prepared cold-rolled steel plates was measured.

Subsequently, the sheets were placed on the surfaces of the cold-rolled steel plates and then heated at 160° C. for 20 minutes to be foamed on the surfaces of the cold-rolled steel plates to obtain foams.

The cold-rolled steel plates and the foams were dipped in water for 24 hours. Then, the cold-rolled steel plates and the foams were pulled out of the water, and the water attached to the surfaces thereof was wiped away. Thereafter, the total mass (C=A2+B) of each of the cold-rolled steel plates and the foam thereon was measured.

The water absorption rate was measured based on the following formula.

$$\begin{matrix}Water Absorption Rate = ( C - ( A 1 + B ) ) / A 1 \times 100 \\ = ( ( A 2 + B ) - ( A 1 + B ) ) / A 1 \times 100 \\ = ( A2 - A 1 ) / A 1 \times 100\end{matrix}$$

where A1 is the mass of the sheet before dipping, A2 is the mass of the sheet after dipping, and B is the mass of the cold-rolled steel plate before and after dipping.

(3) Tensile Shear Adhesion Strength

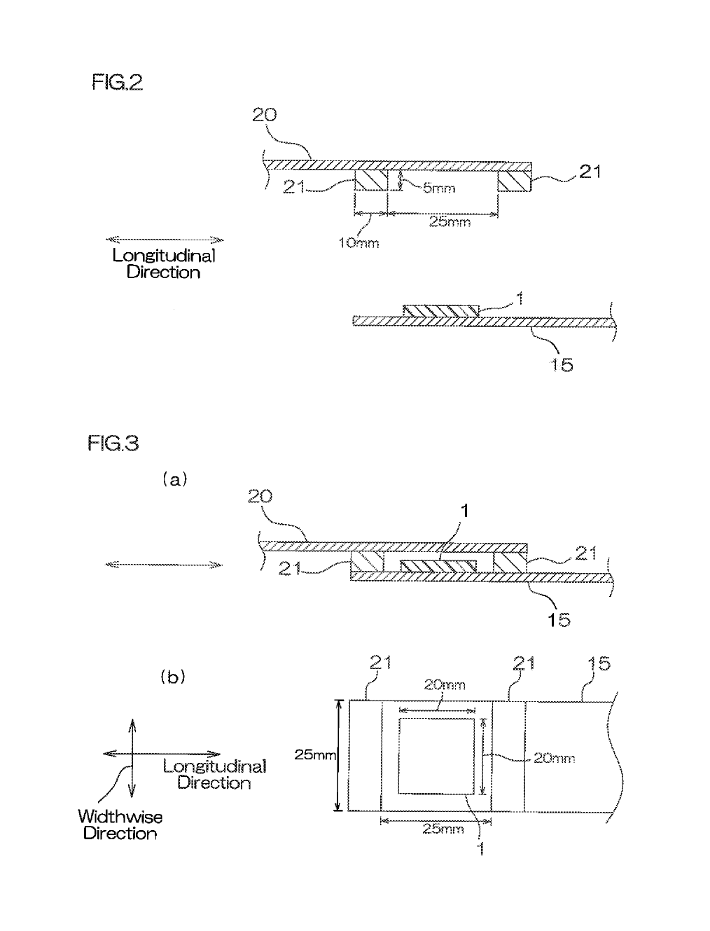

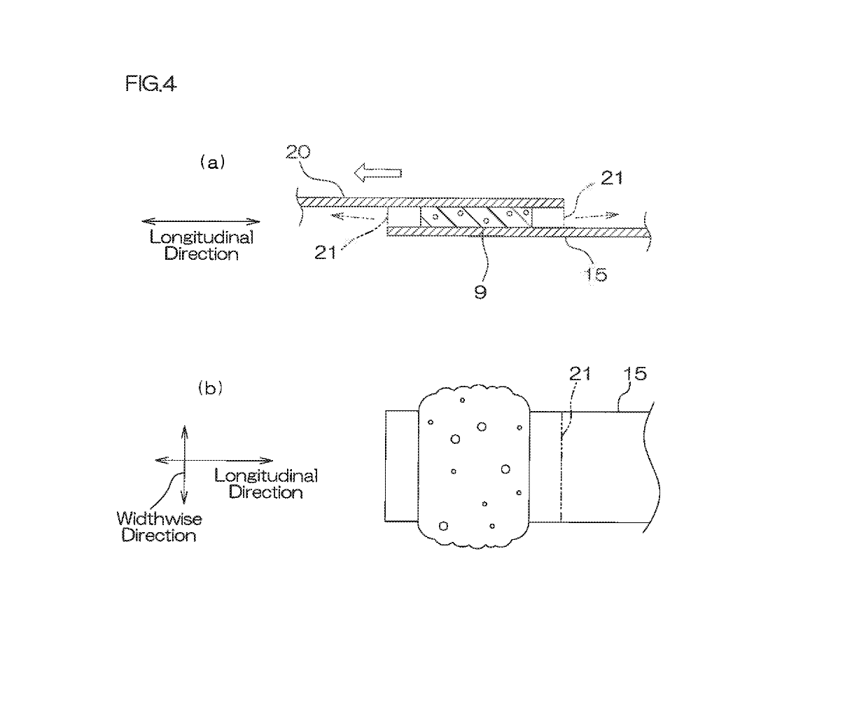

A method of measuring a tensile shear adhesion strength is described with reference to FIGS. 2 to 4. Note that, in FIGS. 3(b) and 4(b), a second steel plate 20 is omitted for clear illustration of relative positioning of the sheet 1 and the foam for filling and sealing 9.

As shown in the lower part of FIG. 2 and in FIG. 3(b), the sheet 1 of each of Examples and Comparative Examples was cut out into a rectangular shape having a size of 20×20 mm. The cut-out sheet 1 was placed on the upper surface of a cold-rolled steel plate (first steel plate) 15 of 100 mm×25 mm as a bonding target.

Meanwhile, as shown in the upper part of FIG. 2, a cold-rolled steel plate (second steel plate) 20 of 100 mm×25 mm as a bonding target was prepared. As shown in the upper part of FIG. 2 and in FIG. 3(b), the lower surface of the second steel plate 20 was provided with two spacers 21 each extending downward and having a rectangular frame shape in plan view. Note that, to each of the inner side surfaces (opposing surfaces facing the sheet 1 shown in FIG. 3 which were contact surfaces in contact with the foam for filling and sealing 9 shown in FIG. 4) of the spacers 21, a polyethylene terephthalate film subjected to silicone treatment was stuck. Each of the spacers 21 had a thickness of 5 mm, a width of 10 mm, and a length of 25 mm. The distance (space in a longitudinal direction) between the adjacent spacers 21 was 25 mm.

Then, as shown in FIGS. 3(a) and 3(b), the first steel plate 15 and the second steel plate 20 were disposed to face each other such that the sheet 1 was interposed therebetween in a vertical direction and also interposed between the spacers 21 in the longitudinal direction (longitudinal direction of the first steel plate 15). Specifically, the lower end portions of the spacers 21 were placed on the upper surface of the first steel plate 15.

Thereafter, as shown in FIGS. 4(a) and 4(b), they were heated at 160° C. for 20 minutes to obtain the foam for filling and sealing 9 molded by the first steel plate 15, the second steel plate 20, and the spacers 21. Note that the foam for filling and sealing 9 protruded outwardly from the both widthwise end portions of each of the first steel plate 15 and the second steel plate 20 on both sides thereof.

Subsequently, as shown by the arrows of the imaginary lines of FIG. 4(a), the spacers 21 were removed. Then, as shown by the arrow of the solid line of FIG. 4(a), by relatively sliding (pulling) the first steel plate 15 with respect to the second steel plate 20 both ways in the longitudinal direction at a tension speed of 50 mm/min, the tensile shear adhesion strength (maximum shear strength) of the foam for filling and sealing 9 with respect to each of the first steel plate 15 and the second steel plate 20 was measured.

Also in the measurement of the tensile shear adhesion strength, the state of failure when the tensile shear occurred was visually observed.

TABLE 1

| | | | | | Examples | | | | | |
|---|---|---|---|---|---|---|---|---|---|---|
| | | | | | Ex. 1 | Ex. 2 | Ex. 3 | Ex. 4 | Ex. 5 | Ex. 6 |
| Blending | Vinyl Copolymer | | | EVA*¹ | 100 | 100 | 100 | 100 | 100 | 100 |
| Formulation | Organic Peroxide | | | DCP*² | 5 | 5 | 5 | 5 | 5 | 5 |
| of Foaming | (Cross-Linking Agent) | | | | | | | | | |
| Composition | Foaming Agent | | | ADCA*³ | 15 | 15 | 15 | 10 | 10 | 10 |
| for Filling | Hydrophobic | | | SBR*⁴ | 10 | — | — | 10 | 20 | 10 |
| and Sealing | Resins | | | NBR*⁵ | — | 10 | — | — | — | — |
| | | | | IIR*⁶ | — | — | 10 | — | — | — |
| | | | | SP Value | 17.6-17.8 | 19.2-20.3 | 15.8-16.7 | 17.6-17.8 | 17.6-17.8 | 17.6-17.8 |
| | Hydro- | Epoxy | Epoxy | Bisphenol | — | — | — | 5 | 5 | 5 |
| | philic | Resin | Resin | A*⁷ | | | | | | |
| | Resins | Compo- | Curing | Dicyandi- | — | — | — | 0.5 | 0.5 | 0.5 |
| | | sitions | Agent | amide*⁸ | | | | | | |
| | | | Curing | Imidazole | — | — | — | 0.2 | 0.2 | 0.2 |
| | | | Accel- | Com- | | | | | | |
| | | | erator | pound*⁹ | | | | | | |

| | | | | | | |
|---|---|---|---|---|---|---|
| Polyamide Resin*¹⁰ | 10 | 10 | 10 | — | — | — |
| SP Value | 27.8 | 27.8 | 27.8 | 22.3 | 22.3 | 22.3 |

| | | | | | | | |
|---|---|---|---|---|---|---|---|
| Cross-Linking | TMPTA*¹¹ | 0.3 | 0.3 | 0.3 | 0.3 | 0.3 | 0.3 |
| Auxiliary Agent | | | | | | | |
| Foaming | Zinc | 5 | 5 | 5 | 5 | 5 | 10 |
| Auxiliary Agents | Oxide*¹² | | | | | | |
| | Zinc | 5 | 5 | 5 | 5 | 5 | 1 |
| | Stearate*¹³ | | | | | | |
| Softener | Aliphatic | 15 | 15 | 15 | 15 | 15 | 15 |
| | Hydrocarbon | | | | | | |
| | Resin*¹⁴ | | | | | | |

| Evaluation | Expansion Ratio | | 11.2 | 10.4 | 11.1 | 9.8 | 10.1 | 10.2 |
|---|---|---|---|---|---|---|---|---|
| | Water Absorption Rate (mass %) | | 4.7 | 4.4 | 4.3 | 7.1 | 8.5 | 3.2 |
| | Adhesion | Tensile Shear | 0.59 | 0.56 | 0.58 | 0.64 | 0.53 | 0.67 |
| | | Adhesion Strength (MPa) | | | | | | |
| | | State of Failure upon | Cohe- | Cohe- | Cohe- | Cohe- | Cohe- | Cohe- |
| | | Application of Tension | sive*¹⁵ | sive*¹⁵ | sive*¹⁵ | sive*¹⁵ | sive*¹⁵ | sive*¹⁵ |

TABLE 2

| | | | | | Comparative Examples | | | | | | | |
|---|---|---|---|---|---|---|---|---|---|---|---|---|
| | | | | | Comp | Comp. | Comp. | Comp. | Comp. | Comp. | Comp. | Comp. |
| | | | | | Ex. 1 | Ex. 2 | Ex. 3 | Ex. 4 | Ex. 5 | Ex. 6 | Ex. 7 | Ex. 8 |
| Blending | Vinyl Copolymer | | | EVA*¹ | 100 | 100 | 100 | 100 | 100 | 100 | 100 | 100 |
| Formulation | Organic Peroxide | | | DCP*² | 5 | 5 | 5 | 5 | 5 | 5 | 5 | 5 |
| of Foaming | (Cross-Linking Agent) | | | | | | | | | | | |
| Composition | Foaming Agent | | | ADCA*³ | 10 | 10 | 15 | 10 | 10 | 10 | 10 | 10 |
| for Filling | Hydrophobic | | | SBR*⁴ | 10 | — | — | — | 30 | 2 | 10 | 10 |
| and Sealing | Resins | | | NBR*⁵ | — | 10 | — | — | — | — | — | — |
| | | | | IIR*⁶ | — | — | — | — | — | — | — | — |
| | | | | SP Value | — | — | — | — | — | — | — | — |
| | Hydro- | Epoxy | Epoxy | Bisphenol | — | — | — | 5 | 5 | 5 | — | — |
| | philic | Resin | Resin | A*⁷ | | | | | | | | |
| | Resins | Compo- | Curing | Dicyandi- | — | — | — | 0.5 | 0.5 | 0.5 | — | — |
| | | sitions | Agent | amide*⁸ | | | | | | | | |
| | | | Curing | Imidazole | — | — | — | 0.2 | 0.2 | 0.2 | — | — |
| | | | Accel- | Com- | | | | | | | | |
| | | | erator | pound*⁹ | | | | | | | | |

| | | | | | | | | |
|---|---|---|---|---|---|---|---|---|
| Polyamide Resin*¹⁰ | — | — | 10 | — | — | — | 0.5 | 30 |
| SP Value | — | — | — | — | — | — | — | — |

| | | | | | | | | | |
|---|---|---|---|---|---|---|---|---|---|
| Cross-Linking | TMPTA*¹¹ | 0.3 | 0.3 | 0.3 | 0.3 | 0.3 | 0.3 | 0.3 | 0.3 |
| Auxiliary Agent | | | | | | | | | |
| Foaming | Zinc | 5 | 5 | 5 | 5 | 5 | 5 | 5 | 5 |
| Auxiliary Agents | Oxide*¹² | | | | | | | | |
| | Zinc | 5 | 5 | 5 | 5 | 5 | 5 | 5 | 5 |
| | Stearate*¹³ | | | | | | | | |
| Softener | Aliphatic | 15 | 15 | 15 | 15 | 15 | 15 | 15 | 15 |
| | Hydrocarbon | | | | | | | | |
| | Resin*¹⁴ | | | | | | | | |

| Evaluation | Expansion Ratio | | 11.4 | 10.5 | 10.1 | 9.9 | 8.9 | 10.2 | 10.2 | 5.6 |
|---|---|---|---|---|---|---|---|---|---|---|
| | Water Absorption Rate (mass %) | | 1.9 | 4.6 | 10.7 | 13.9 | 7.2 | 12.6 | 2.1 | 6.1 |
| | Adhesion | Tensile Shear | 0.49 | 0.42 | 0.54 | 0.68 | 0.44 | 0.65 | 0.45 | 1.24 |
| | | Adhesion Strength (MPa) | | | | | | | | |
| | | State of Failure upon | Inter- | Inter- | Cohe- | Cohe- | Inter- | Cohe- | Inter- | Cohe- |
| | | Application of Tension | facial*¹⁶ | facial*¹⁶ | sive*¹⁵ | sive*¹⁵ | facial*¹⁶ | sive*¹⁵ | facial*¹⁶ | sive*¹⁵ |

Note that the values in Tables 1 and 2 show the respective numbers of parts by mass of the individual components unless otherwise specified.

In Tables 1 and 2, the compounds and evaluation each indicated by the mark “*” are described below in detail.

*1: Ethylene-vinyl acetate copolymer available under the trade name of “EVAFLEX EV560” and having a vinyl acetate content of 14 mass % and MFR of 3.5 g/10 min

*2: Dicumyl peroxide available from NOF Corporation Co., Ltd. under the trade name of “PERCUMYL D-40 MBK” and having a DCP content of 40% and a silica plus EPDM content of 60 mass %

*3: Azodicarbonamide available from Eiwa Chemical Industrial Co., Ltd. under the trade name of “Vinyhole AC#3C”

*4: Available from Asahi Kasei Corporation under the trade name of “Tafuden 2003” and having a styrene content of 25 mass %, an SP value of 17.6 to 17.8, and a Mooney viscosity of 33 (ML1+4 at 100° C.)

*5: Nipol 1052J available from Nippon Zeon Co., Ltd. and having a nitrile content of 33.5 mass %, an SP value of 19.2 to 20.3, and a Mooney viscosity of 46 (ML1+4 at 100° C.)

*6: JSR BUTYL 268 available from JSR Corporation and having an unsaturation degree of 1.5 mol %, an SP value of 15.8 to 16.7, and a Mooney viscosity of 51 (ML1+8 at 125° C.)

*7: Bisphenol A type epoxy resin available from Mitsubishi Chemical Corporation under the trade name of “jER 834” and having an SP value of 22.3 and an epoxy equivalent of 230 to 270 g/equiv.

*8: Available from PTI Japan Co. under the trade name of “DDA50”

*9: 2,4-diamino-6[2′-methylimidazolyl-(1′)]-ethyl-s-triazine isocyanuric acid adduct available from Sikoku Kasei Co., Ltd. under the trade name of “2MA-OK”

*10: Available from Fuji Kasei Kogyo Co. Ltd. under the trade name of “PA-100” and having an SP value of 27.8

*11: Trimethylol propane triacrylate available from Osaka Organic Chemical Industry Ltd. under the trade name of “TMP3A”

*12: Available from Mitsui Mining & Smelting Co., Ltd. under the trade name of “Zinc Oxide #2”

*13: Available from Sakai Chemical Industry Co., Ltd. under the trade name of “SZ-P”

*14: available from Nippon Zeon Co., Ltd. under the trade name of “Quintone G100B” and having a softening temperature (measured by a ring and ball method at a temperature rising rate of 5° C./min) of 100° C.

*15: State where a middle portion of the sheet in the thickness direction thereof was sheared

*16: State where the interface between the sheet and the first or second steel plate was sheared

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The foam for filling and sealing that can be obtained by foaming the foaming composition for filling and sealing is used preferably as fillers/sealers for various industrial products such as, e.g., a reinforcement material, a vibration control material, a sound insulator, a dust control material, a heat insulator, a buffering material, and a waterstop material.

1. A foaming composition for filling and sealing, containing:
a vinyl copolymer having an ester bond in a side chain thereof;
an organic peroxide;
a foaming agent;
a hydrophobic resin; and
a hydrophilic resin, wherein
a content ratio of the hydrophobic resin is in a range of 5 to 25 parts by mass based on 100 parts by mass of the vinyl copolymer, and
a content ratio of the hydrophilic resin is in a range of 1 to 20 parts by mass based on 100 parts by mass of the vinyl copolymer.

2. A foaming composition for filling and sealing according to claim 1, wherein the vinyl copolymer is an ethylene-vinyl acetate copolymer.

3. A foaming composition for filling and sealing according to claim 1, wherein the hydrophobic resin is at least one synthetic rubber selected from the group consisting of a styrene-butadiene rubber, an acrylonitrile-butadiene rubber, and a butyl rubber.

4. A foaming composition for filling and sealing according to claim 1, wherein the hydrophilic resin is an epoxy resin and/or a polyamide resin.

5. A foaming composition for filling and sealing according to claim 1, wherein the foaming agent is azodicarbonamide.

6. A foaming member for filling and sealing, comprising:
a foaming composition for filling and sealing; and
a fitting member attached to the foaming composition for filling and sealing to be capable of being mounted in an inner space of a hollow member, wherein
the foaming composition for filling and sealing contains a vinyl copolymer having an ester bond in a side chain thereof, an organic peroxide, a foaming agent, a hydrophobic resin, and a hydrophilic resin,
a content ratio of the hydrophobic resin is in a range of 5 to 25 parts by mass based on 100 parts by mass of the vinyl copolymer, and
a content ratio of the hydrophilic resin is in a range of 1 to 20 parts by mass based on 100 parts by mass of the vinyl copolymer.

7. A foam for filling and sealing obtained by foaming a foaming composition for filling and sealing containing a vinyl copolymer having an ester bond in a side chain thereof, an organic peroxide, a foaming agent, a hydrophobic resin, and a hydrophilic resin, wherein
a content ratio of the hydrophobic resin is in a range of 5 to 25 parts by mass based on 100 parts by mass of the vinyl copolymer, and
a content ratio of the hydrophilic resin is in a range of 1 to 20 parts by mass based on 100 parts by mass of the vinyl copolymer.
